(19) United States
(12) Patent Application Publication
(10) Pub. No.: US 2014/0324927 A1
(43) Pub. Date: Oct. 30, 2014

(54) METHOD, IM CLIENT AND CLOUD SERVER FOR SAVING CHAT RECORD

(71) Applicants: Xiao Long Zhang, Shenzhen (CN); Xing Liang, Shenzhen (CN); Yiheng Liu, Shenzhen (CN)

(72) Inventors: Xiao Long Zhang, Shenzhen (CN); Xing Liang, Shenzhen (CN); Yiheng Liu, Shenzhen (CN)

(21) Appl. No.: 13/993,299

(22) PCT Filed: Apr. 27, 2013
(86) PCT No.: PCT/CN13/74910

§ 371 Date: Jun. 11, 2013

(51) Int. Cl. G06F 17/30

(52) U.S. Cl. CPC G06F 17/30091
USPC 707/825

(57) ABSTRACT

Examples of the present disclosure provide a method, an Instant Messaging (IM) client and a cloud server for saving a chat record. The method includes: receiving, by an IM client, a request for saving a chat record; obtaining, by the IM client, a corresponding chat record according to the request; and transmitting, by the IM client, the obtained chat record to a cloud server, in which the cloud server comprises at least one of an Email server and a network hard disc. By employing the method, IM client and the cloud server provided by the present disclosure, chat record may be viewed on different platforms with different terminals, and user experience may be improved.

### FIELD

The present disclosure relates to Instant messaging (IM) technologies, and more particularly, to a method, an IM client and a cloud server for saving a chat record.

### BACKGROUND

In recent years, instant messaging (IM) tools have been accepted by the majority of Internet users and become essential network tools. It should be noted that, network IM tools are widely used not only in usual entertainment, but also in users' work. The IM tools are frequently used by the users to communicate with their friends, colleagues and students in life and work. Therefore, users may put forward higher requirements in ease of use, stability, security and other aspects of IM tools (such as IM software).

With continuous development of IM technologies, WeChat appears. The WeChat is growing steadily as a new product and new application with information transmission mechanism of IM tools. The WeChat supports to rapidly transmit voice short message, video, picture and characters from a WeChat user to another WeChat, and supports a group chat.

When a WeChat client is a mobile phone, the capacity thereof is always limited. In most cases, users may wish to save video, picture, music and movie in the mobile phone. Subsequently, capacity for saving chat record of the mobile phone is relatively small.

Generally speaking, when a WeChat user chats with another WeChat user, chat record may be saved in WeChat clients of the two WeChat users. When a WeChat user chats in a group, chat record may be saved in a WeChat client of each WeChat user in the group. For example, when the IM client is a mobile phone, the user may be not able to view the chat record once the mobile phone is lost, or the mobile phone is not at hand.

### SUMMARY

Various examples of the present disclosure provide a method, an IM client and a cloud server for saving a chat record, to facilitate to view the chat record subsequently.

According to one example of the present disclosure, a method for saving a chat record is provided, which includes: receiving, by an Instant Messaging IM client, a request for saving a chat record; obtaining, by the IM client, a corresponding chat record according to the request; and transmitting, by the IM client, the obtained chat record to a cloud server, in which the cloud server includes at least one of an Email server and a network hard disc.

According to another example of the present disclosure, an IM Client is provided, which includes a processor, a memory and an interface, wherein the interface is configured to receive a request for saving a chat record; the processor is configured to obtain a corresponding chat record saved in the memory according to the request, and transmit the obtained chat record to a cloud server, in which the cloud server includes at least one of the Email server and the network hard disc.

According to another example of the present disclosure, a cloud server for saving a chat record is provided, which includes a processor, a memory and an interface, wherein the interface is configured to receive a chat record from an IM client; the memory is configured to save the chat record; and the processor is configured to provide the chat record saved in the memory, such that the chat record is to be presented, when the interface receives a viewing request, in which the cloud server includes at least one of the Email server and the network hard disc.

By employing the method, IM client and cloud server provided by the present disclosure, capacity capable of saving chat record may be not limited to the capacity of the IM client. Furthermore, the chat record of an IM user may be viewed on different platforms with different terminals. Subsequently, chat record may be viewed more conveniently, and user experience may be improved.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for saving a chat record, in accordance with an example of the present disclosure.

FIG. 2 is a block diagram illustrating structure of an Instant Messaging (IM) client, in accordance with an example of the present disclosure.

FIG. 3 is a block diagram illustrating structure of the transmitting module 204 of the IM client shown in FIG. 2, in accordance with an example of the present disclosure.

FIG. 4 is a block diagram illustrating structure of an IM client, in accordance with another example of the present disclosure.

FIG. 5 is a block diagram illustrating structure of a cloud server, in accordance with an example of the present disclosure.

FIG. 6 is a block diagram illustrating structure of a cloud server, in accordance with another example of the present disclosure.

FIG. 7 is a block diagram illustrating structure of a cloud server, in accordance with still another example of the present disclosure.

### DETAILED DESCRIPTION

Hereinafter, the present disclosure will be described in further detail with reference to the accompanying drawings and examples to make the technical solution and merits therein clearer.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In the following examples of the present disclosure, the chat record may be IM record, such as record of WeChat, QQ, ICQ, MSN Messenger, Skype, Fetion, AIM, GoogleTalk, MyspaceIM, Sametime, Gadu Gadu, etc.

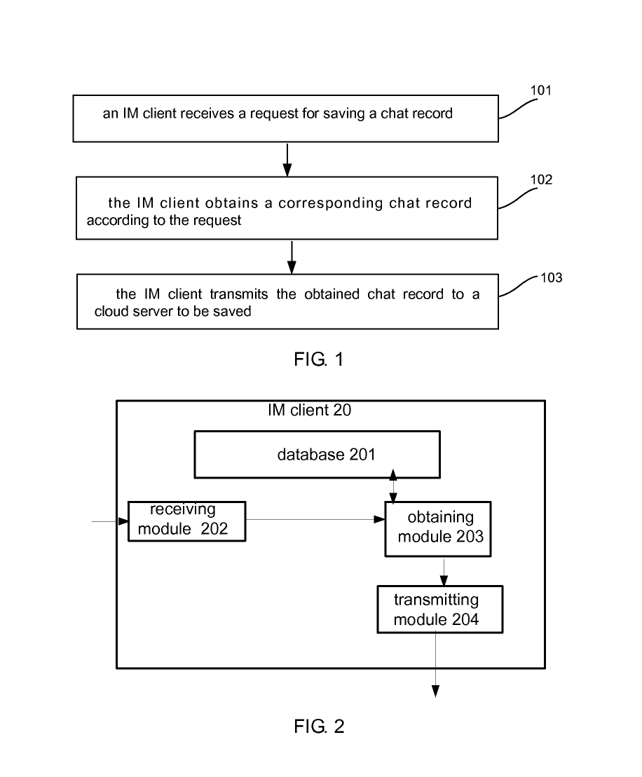

FIG. 1 is a flowchart illustrating a method for saving a chat record, in accordance with an example of the present disclosure. As shown in FIG. 1, the method may include the following blocks.

Block 101, an Instant Messaging (IM) client receives a request for saving a chat record.

Specifically speaking, the request may include a chat object identifier and a time period identifier, indicating the chat record with which chat object within a time period indicated by the time period identifier needs to be saved. Alternatively, the request may also include a chat group identifier and a time period identifier, indicating the chat record about which chat group within a time period indicated by the time period identifier needs to be saved.

Block 102: the IM client obtains a corresponding chat record according to the request.

Specifically speaking, when the request for saving the chat record includes the chat object identifier and the time period identifier, the IM client may copy the corresponding chat record with a chat object indicated by the chat object identifier during a time period, which is indicated by the time period identifier, according to the chat object identifier and time period identifier carried in the request.

When the request for saving the chat record includes the chat group identifier and the time period identifier, the IM client may copy the corresponding chat record about a chat group indicated by the chat group identifier during a time period, which is indicated by the time period identifier, according to the chat group identifier and the time period identifier carried in the request.

Generally speaking, for security reasons, the chat record is always saved in an IM client with an encrypted database format. After obtaining the corresponding chat record according to the request, the IM client may convert an initial format of the chat record into a readable format. For example, the IM client may convert the format of the chat record from an encrypted database format to an HTML format, to facilitate subsequent viewing.

Block 103: the IM client transmits the obtained chat record to a cloud server, in which the cloud server includes at least one of an Email server and a network hard disc.

When the IM client has converted the initial format of the chat record into a readable format, such as the HTML format, the IM client may transmit the chat record with changed format to the cloud server to be saved through a network, such as the Internet.

Generally speaking, the cloud server may include, but not limited to, an Email server, a network hard disk, or both of them.

When the cloud server includes the Email server, the IM client may transmit the obtained chat record to the Email sever to be saved.

When the cloud server includes the network hard disk, the IM client may transmit the obtained chat record to the network hard disk to be saved. When the cloud server includes the Email server and the network hard disk, the IM client may transmit the obtained chat record to the network hard disk to be saved via the Email sever. Or, the IM client may transmit the obtained chat record to the Email server, in which the chat record is to be transmitted by the Email server to the network hard disk. As a specific implementation mode, the chat record may also be synchronized by the Email server with the network hard disc. Still or, the IM client may transmit the obtained chat record to the network hard disk, in which the chat record is to be transmitted by the network hard disk to the Email server. As a specific implementation mode, the chat record may also be synchronized by the network hard disc with the Email server. In the latter two scenarios, the chat record may be saved in both of the Email server and the network hard disk.

Subsequently, when the cloud server is the Email server, a user may log on an Email via a client to view the chat record. When the cloud server is the network hard disc, a user may log on the network hard disc via a client to view the chat record. When the cloud server is the Email server and the network hard disc, a user may log on the Email server or the network hard disc via a client to view the chat record.

FIG. 2 is a block diagram illustrating structure of an IM client, in accordance with an example of the present disclosure. As shown in FIG. 2, the IM client 20 includes a database 201, a receiving module 202, an obtaining module 203 and a transmitting module 204.

The database 201 is configured to save a chat record of an IM user A of IM client 20.

For example, the database 201 may save the chat record between IM users A and B, or the chat record in a certain chat group of IM user A.

The receiving module 202 is configured to receive a request for saving a chat record.

Specifically speaking, the request may include a chat object identifier and a time period identifier, indicating the chat record with which chat object within a time period indicated by the time period identifier needs to be saved.

Alternatively, the request may also include a chat group identifier and a time period identifier, indicating the chat record about which chat group within a time period indicated by the time period identifier needs to be saved.

The obtaining module 203 is configured to obtain a corresponding chat record according to the request.

Specifically speaking, when the request for saving the chat record includes the chat object identifier and the time period identifier, the obtaining module 203 may copy the corresponding chat record with a chat object indicated by the chat object identifier during a time period from the database 201, in which the time period is indicated by the time period identifier, according to the chat object identifier and time period identifier carried in the request received by the receiving module 202.

For example, when the receiving module 202 in the IM client 20 of IM user A receives the request for saving the chat record, the chat object identifier and time period identifier in the request are respectively “user B” and “April, 2013”. The request may indicate to save the chat record between users A and B during April, 2013 in a cloud server.

When the request for saving the chat record includes the chat group identifier and the time period identifier, the obtaining module 203 may copy the corresponding chat record about a chat group indicated by the chat group identifier during a time period from the database 201, in which the time period is indicated by the time period identifier, according to the chat group identifier and the time period identifier carried in the request received by the receiving module 202

For example, when the receiving module 202 in the IM client 20 of IM user A receives the request for saving the chat record, the chat group identifier and time period identifier in the request are respectively “colleague” and “April, 2013”. The request may indicate to save the chat record of group “colleague” of user A during April, 2013 in a cloud server.

As mentioned above, the obtaining module 203 may copy the corresponding chat record, which means that the chat record saved in the database 201 of the IM client 20 may not be affected in most of the cases, when the request carries the “copy” field.

However, when the request for saving the chat record received by the receiving module 202 carries the “cut” field, the obtaining module 203 may copy the corresponding chat record from the database 201, and then remove the corresponding chat record from the database 201, which may be used when the IM client 20 lacks of capacity.

Generally speaking, for security reasons, the chat record is always saved in the database 201 with an encrypted database format. After obtaining the corresponding chat record according to the request, the obtaining module 203 of the IM client 20 may convert an initial format of the chat record into a readable format. For example, the obtaining module 203 of the IM client 20 may convert the format of the chat record from an encrypted database format to an HTML format, to facilitate subsequent viewing.

The transmitting module 204 is configured to transmit the obtained chat record to a cloud server to be saved.

When the obtaining module 203 has converted the initial format of the chat record into a readable format, such as the HTML format, the transmitting module 204 may transmit the chat record with changed format to the cloud server to be saved through a network, such as the Internet.

Generally speaking, the cloud server may include, but is not limited to, an Email server, a network hard disk, or both of them.

When the cloud server includes the Email server, the transmitting module 204 may transmit the obtained chat record to the Email sever to be saved. When the cloud server includes the network hard disk, the transmitting module 204 may transmit the obtained chat record to the network hard disk to be saved.

When the cloud server includes the Email server and the network hard disk, the transmitting module 204 may transmit the obtained chat record to the network hard disk to be saved via the Email sever. Or, the transmitting module 204 may transmit the obtained chat record to the Email server, in which the chat record is to be transmitted by the Email server to the network hard disk. As a specific implementation mode, the chat record may also be synchronized by the Email server with the network hard disc. Still or, the transmitting module 204 may transmit the obtained chat record to the network hard disk, in which the chat record is to be transmitted by the network hard disk to the Email server. As a specific implementation mode, the chat record may also be synchronized by the network hard disk with the Email server. In the latter two scenarios, the chat record may be saved in both of the Email server and the network hard disk.

Subsequently, after receiving a viewing request, the cloud server may provide the saved chat record, such that the chat record is to be presented, to facilitate subsequent viewing.

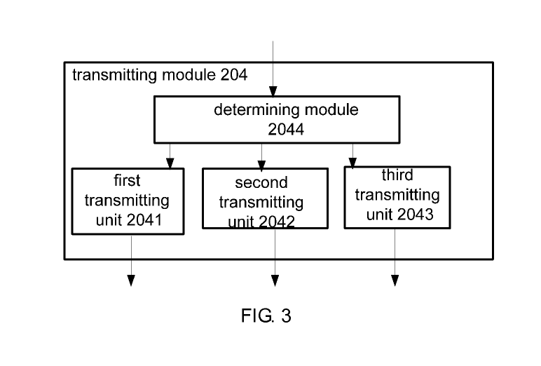

FIG. 3 is a block diagram illustrating structure of the transmitting module 204 of the IM client shown in FIG. 2, in accordance with an example of the present disclosure.

As shown in FIG. 3, the transmitting module 204 may include a first transmitting unit 2041, a second transmitting unit 2042, a third transmitting unit 2043 and a determining unit 2044.

When the determining module 2044 determines that the cloud server to save the chat record is an Email server, the first transmitting unit 2041 is configured to transmit the chat record to the Email server.

When the determining module 2044 determines that the cloud server to save the chat record is a network hard disc, the second transmitting unit 2042 is configured to transmit the chat record to the network hard disc.

When the determining module 2044 determines that the cloud server to save the chat record is an Email server and a network hard disc, the third transmitting unit 2043 is configured to transmit the chat record to the network hard disc via the Email server

Alternatively, when the determining module 2044 determines that the cloud server to save the chat record is an Email server and a network hard disc, the third transmitting unit 2043 is configured to transmit the chat record to the Email server, and the Email server may transmit the chat record to the network hard disc. As a specific implementation mode, the Email server may also synchronize the chat record with the network hard disc.

Still alternatively, when the determining module 2044 determines that the cloud server to save the chat record is an Email server and a network hard disc, the third transmitting unit 2043 is configured to transmit the chat record to the network hard disc, and the network hard disc may transmit the chat record to the Email server. As a specific implementation mode, the network hard disc may synchronize the chat record with the Email server.

It should be noted that, the cloud server is not limited to the Email server and the network hard disc.

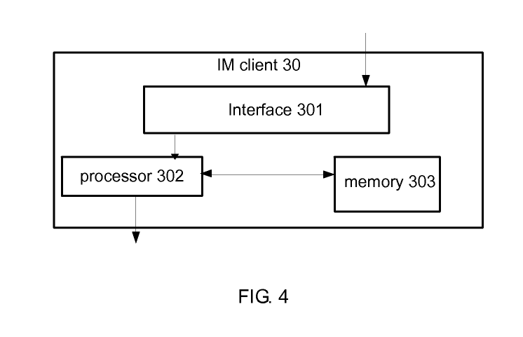

FIG. 4 is a block diagram illustrating structure of an IM client, in accordance with another example of the present disclosure. As shown in FIG. 4, the IM client 30 includes an interface 301, a processor 302 and memory 303. The interface 301 is configured to receive a request for saving a chat record.

Specifically speaking, the request may include a chat object identifier and a time period identifier, indicating the chat record with which chat object within a time period indicated by the time period identifier needs to be saved.

Alternatively, the request may also include a chat group identifier and a time period identifier, indicating the chat record about which chat group within a time period indicated by the time period identifier needs to be saved.

The processor 302 is configured to obtain a corresponding chat record stored in the memory 303 according to the request received by the interface 301, and transmit the obtained chat record to a cloud server to be saved.

Specifically speaking, when the request for saving the chat record includes the chat object identifier and the time period identifier, the processor 302 may copy the corresponding chat record with a chat object indicated by the chat object identifier during a time period from the memory 303, in which the time period is indicated by the time period identifier, according to the chat object identifier and time period identifier carried in the request received by the interface 301.

When the request for saving the chat record includes the chat group identifier and the time period identifier, the processor 302 may copy the corresponding chat record about a chat group indicated by the chat group identifier during a time period from the memory 303, in which the time period is indicated by the time period identifier, according to the chat group identifier and the time period identifier carried in the request received by the interface 301.

Generally speaking, for security reasons, the chat record is always saved in the memory 303 with an encrypted format, such as, but is not limited to, an encrypted database format. The following example is provided, suppose an initial format of the chat record stored in the memory 303 is an encrypted database format.

After obtaining the corresponding chat record according to the request received by the interface 301, the processor 302 may convert the initial format of the chat record into a readable format, such as an HTML format, to facilitate subsequent viewing.

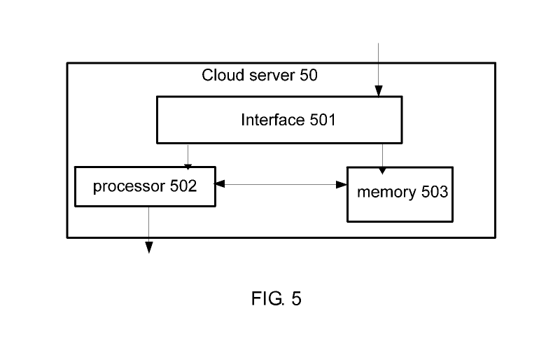

FIG. 5 is a block diagram illustrating structure of a cloud server, in accordance with an example of the present disclosure. Generally speaking, the cloud server may include, but not limited to, at least one of an Email server and a network hard disc.

As shown in FIG. 5, the cloud server 50 may include an interface 501, a processor 502, and a memory 503.

The interface 501 is configured to receive a chat record from an IM client. The memory 503 is configured to save the chat record; and the processor 502 is configured to provide the saved chat record, such that the chat record is to be presented, when the interface 501 receives a viewing request.

When the cloud server is the Email server, the interface 501, the processor 502 and the memory 503 belong to the Email server.

Similarly, when the cloud server is the network hard disc, the foregoing interface 501, the processor 502 and the memory 503 belong to the network hard disc.

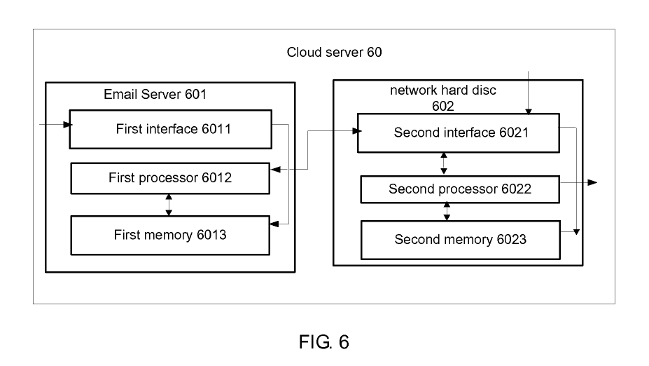

FIG. 6 is a block diagram illustrating structure of a cloud server 60, in accordance with another example of the present disclosure.

The example is provided, suppose the cloud server includes an Email server 601 and a network hard disc 602. As shown in FIG. 6, the Email server may include the first interface 6011, the first processor 6012 and the first memory 6013. Similarly, the network hard disc 602 may include the second interface 6021, the second processor 6022 and the second memory 6023.

The first interface 6011 is configured to receive the chat record transmitted by an IM client, such as a WeChat Client.

The first memory 6013 is to buffer the chat record. The first processor 6012 is configured to transmit the chat record to the second interface 6021. The second interface 6021 is configured to receive the chat record from the first processor 6012.

The second memory 6023 is configured to save the chat record, which is received by the second interface 6021. The second processor 6022 is configured to provide the chat record, such that the chat record is to be presented, when the second interface 6021 receives a viewing request. It should be noted that, in the example, the chat record may be not saved in the Email server. Subsequently, an IM client, such as a WeChat client, may view the chat record with the network hard disc.

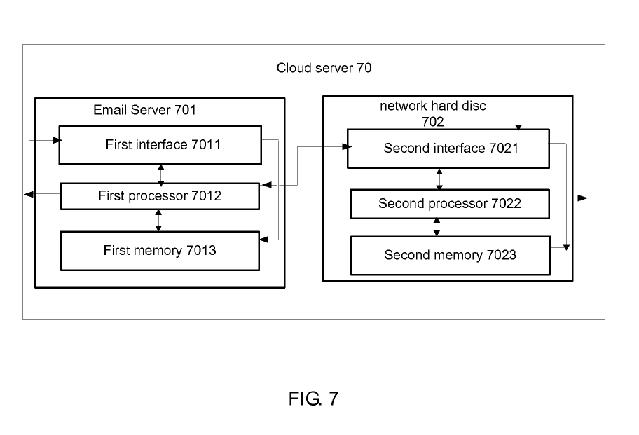

FIG. 7 is a block diagram illustrating structure of a cloud server 70, in accordance with another example of the present disclosure.

The example is provided, suppose the cloud server 70 includes an Email server 701 and a network hard disc 702. It should be noted that, alternatively, the cloud server may include at least three other specific servers, the basic principle may be similar.

As shown in FIG. 7, the Email server 701 may include the first interface 7011, the first processor 7012 and the first memory 7013. Similarly, the network hard disc 702 may include the second interface 7021, the second processor 7022 and the second memory 7023.

The first interface 7011 is configured to receive the chat record transmitted by an IM client, such as a WeChat Client.

The first memory 7013 is configured to save the chat record. The first processor 7012 is configured to transmit the chat record to the network hard disc 702. As a specific implementation mode, the first processor 7012 may also be configured to synchronize the chat record with the network hard disc 702. And subsequently, the first processor 7012 may provide the chat record saved in the first memory 7013, such that the chat record is to be presented, when the first interface 7011 receives a viewing request.

The second interface 7021 is configured to receive the chat record from the first processor 7012.

The second memory 7023 is configured to save the chat record, which is received by the second interface 7021.

The second processor 7022 is configured to provide the chat record saved in the second memory 7023, such that the chat record is to be presented, when the second interface 7021 receives a viewing request.

Alternatively, when the cloud server includes the Email server and the network hard disc, the chat record may be firstly received and saved by the network hard disc, and then, the network hard disc may transmit the chat record to the Email server. As a specific implementation mode, the network hard disc may synchronize the chat record with the Email server, which is similar to the example illustrated with FIG. 7, and is not repeated here.

By employing the method, IM client and cloud server provided by the present disclosure, capacity capable of saving chat record may be not limited to the capacity of the IM client. Furthermore, the chat record of an IM user may be viewed on different platforms with different terminals. Subsequently, chat record may be viewed more conveniently, and user experience may be improved.

The figures are only illustrations of an example, wherein the modules or procedure shown in the figures are not necessarily essential for implementing the present disclosure. The modules in the aforesaid examples can be combined into one module or further divided into a plurality of sub-modules.

What is claimed is:

1. A method for saving a chat record, comprising:
receiving, by an Instant Messaging (IM) client, a request for saving a chat record;
obtaining, by the IM client, a corresponding chat record according to the request; and
transmitting, by the IM client, the obtained chat record to a cloud server, wherein the cloud server comprises at least one of an Email server and a network hard disc.

2. The method according to claim 1, wherein the request comprises a chat object identifier and a time period identifier;
obtaining by the IM client the corresponding chat record according to the request comprises:
copying, by the IM client, the corresponding chat record with a chat object indicated by the chat object identifier during a time period, which is indicated by the time period identifier, according to the chat object identifier and the time period identifier carried in the request.

3. The method according to claim 1, wherein the request comprises a chat group identifier and a time period identifier;
obtaining by the IM client the corresponding chat record according to the request comprises:
copying, by the IM client, the corresponding chat record about a chat group indicated by the chat group identifier during a time period, which is indicated by the time period identifier, according to the chat group identifier and the time period identifier carried in the request.

4. The method according to claim 1, further comprising:
before transmitting by the IM client the obtained chat record to the cloud server, converting, by the IM client, a format of the obtained chat record.

5. The method according to claim 4, wherein converting by the IM client the format of the obtained chat record comprises:
converting, by the IM client, the format of the obtained chat record from an encrypted database format to an HTML format.

6. The method according to claim 1, wherein when the cloud server comprises the Email server and the network hard disk, transmitting by the IM client the obtained chat record to the cloud server comprises:
transmitting, by the IM client, the obtained chat record to the network hard disk via the Email server;
or,
transmitting, by the IM client, the obtained chat record to the Email server, wherein the chat record is to be transmitted by the Email server to the network hard disk;
or,
transmitting, by the IM client, the obtained chat record to the network hard disk, wherein the chat record is to be transmitted by the network hard disk to the Email server.

7. The method according to claim 1, wherein when the cloud server comprises the Email server, transmitting by the IM client the obtained chat record to the cloud server comprises:
transmitting, by the IM client, the obtained chat record to the Email server;
when the cloud server comprises the network hard disc, transmitting by the IM client the obtained chat record to the cloud server comprises:
transmitting, by the IM client, the obtained chat record to the network hard disc.

8. The method according to claim 1, further comprising:
providing, by the cloud server, the chat record, such that the chat record is to be presented.

9. An Instant Messaging (IM) Client, comprising a processor, a memory and an interface, wherein
the interface is configured to receive a request for saving a chat record;
the processor is configured to obtain a corresponding chat record saved in the memory according to the request, and transmit the obtained chat record to a cloud server, wherein the cloud server comprises at least one of an Email server and a network hard disc.

10. The IM client according to claim 9, wherein the request comprises a chat object identifier and a time period identifier, and
the processor is configured to copy the corresponding chat record with a chat object indicated by the chat object identifier during a time period, which is indicated by the time period identifier, according to the chat object identifier and the time period identifier carried in the request.

11. The IM client according to claim 9, wherein the request comprises a chat group identifier and a time period identifier, and
the processor is configured to copy the corresponding chat record about a chat group indicated by the chat group identifier during a time period, which is indicated by the time period identifier, according to the chat group identifier and the time period identifier carried in the request.

12. The IM client according to claim 9, wherein the processor is further configured to convert a format of the obtained chat record, before transmitting the obtained chat record to the cloud server.

13. The IM client according to claim 9, wherein the processor is further configured to convert a format of the obtained chat record from an encrypted database format to an HTML format, before transmitting the obtained chat record to the cloud server.

14. A cloud server for saving a chat record, comprising a processor, a memory and an interface, wherein
the interface is configured to receive a chat record from an Instant Messaging (IM) client;
the memory is configured to save the chat record; and
the processor is configured to provide the chat record saved in the memory, such that the chat record is to be presented, when the interface receives a viewing request;
wherein the cloud server comprises at least one of an Email server and a network hard disc.

15. The cloud server according to claim 14, wherein when the cloud server comprises the Email server and the network hard disk, the Email server comprises a first interface, a first processor and a first memory, the network hard disk comprises a second interface, a second processor and a second memory, and
the first interface is configured to receive the chat record from the IM client;
the first memory is configured to buffer the chat record;
the first processor is configured to transmit the chat record to the second interface;
the second interface is configured to receive the chat record;
the second memory is configured to save the chat record;
the second processor is configured to provide the chat record saved in the second memory, such that the chat record is to be presented, when the second interface receives a viewing request.

16. The cloud server according to claim 14, wherein when the cloud server comprises the Email server and the network hard disk, the Email server comprises a first interface, a first processor and a first memory, the network hard disk comprises a second interface, a second processor and a second memory, and
the first interface is configured to receive the chat record from the IM client;
the first memory is configured to save the chat record;
the first processor is configured to transmit the chat record to the network hard disc;
the second interface is configured to receive the chat record from the first processor;
the second memory is configured to save the chat record received by the second interface;
the first processor is further configured to provide the chat record saved in the first memory, such that the chat record is to be presented, when the first interface receives a viewing request, and
the second processor is configured to provide the chat record saved in the second memory, such that the chat record is to be presented, when the second interface receives a viewing request.

17. The cloud server according to claim 14, wherein when the cloud server comprises the Email server and the network hard disk, the Email server comprises a first interface, a first processor and a first memory, the network hard disk comprises a second interface, a second processor and a second memory, and
the second interface is configured to receive the chat record from the IM client;
the second memory is configured to save the chat record;
the second processor is configured to transmit the chat record to the Email server;
the first interface is configured to receive the chat record from the second processor;
the first memory is configured to save the chat record received by the first interface;
the first processor is further configured to provide the chat record saved in the first memory, such that the chat record is to be presented, when the first interface receives a viewing request, and
the second processor is further configured to provide the chat record saved in the second memory, such that the chat record is to be presented, when the second interface receives a viewing request.
